(19) United States
(12) Patent Application Publication
(10) Pub. No.: US 2018/0130358 A1
(43) Pub. Date: May 10, 2018

(54) Device, System and Method for Dynamic Airspace Use

(71) Applicant: PASSUR Aerospace, Inc., STAMFORD, CT (US)

(72) Inventor: Leo PRUSAK, Stamford, CT (US)

(21) Appl. No.: 15/344,046

(22) Filed: Nov. 4, 2016

(51) Int. Cl. G08G 5/00; B64C 39/02

(52) U.S. Cl. CPC G08G 5/006; G08G 5/0091; G08G 5/0069; B64C 39/024; G08G 5/0026

(57) ABSTRACT

A device, system, and method dynamically determines airspace availability. The method performed at an airspace predictor server includes determining a current condition present at an airport. The method includes querying historical data having a historical condition that is substantially similar to the current condition. The method includes determining a portion of a zone surrounding the airport that was utilized by aircraft under the historical condition. The method includes determining an available airspace for the current condition as a difference between the zone and the portion.

### BACKGROUND INFORMATION

An airport provides a location in which aircraft may land and/or take-off. A goal of the airport is to optimize the take-off and landing slots to maximize the number of aircraft that can take-off and land. To provide the most efficient slot scheduling, knowledge of expected demand at any particular time during the day may provide insight to an airport operator, to smooth out any demand/capacity imbalances in the slot scheduling. Furthermore, the time during the day may also utilize different directions and/or paths in which the aircraft take-off and land. Thus, knowledge of the demand and paths of aircraft taking-off and landing may provide further insight to the slot scheduling.

The slot scheduling at the airport relates to the use of airspace for manned aircraft (e.g., passenger flights). However, the use of drones or unmanned aircraft also utilizes the airspace. When the airspace is within a close proximity to an airport, the use of this airspace is an essential element for unmanned aircraft operations. For example, the Federal Aviation Administration (FAA) recently created Federal Aviation Regulation (FAR) 107 that defines that unmanned aircraft (commercial and personal) require approval to use airspace within 5 miles of an airport. Furthermore, airport runway use, which determines airport airspace availability is generally a function of weather factors. Wind speed, precipitation, wind direction, cloud ceiling, and visibility are basic elements for runway selection or configuration which may be forecast by the National Weather Service. With the airport optimizing the slot scheduling of manned aircraft taking-off and landing, the airport operator may be unable to forecast runway configuration and airspace use for a period of upcoming time (e.g., the next 16 hours) within 5 miles that may be available for unmanned aircraft. The forecast use of this airspace enables airspace planning and scheduling that is critical for drone operations.

Accordingly, there is a need to be able to forecast for a period of upcoming time (e.g., over the next 16 hours) whether an unmanned aircraft will be allowed to utilize a particular area of airspace within 5 miles of the airport such that requests from an operator of the unmanned aircraft may be responded to without affecting the use of airspace by manned aircraft.

### SUMMARY

The exemplary embodiments are directed to a method, comprising: at an airspace predictor server: determining a current condition present at an airport; querying historical data having a historical condition that is substantially similar to the current condition; determining a portion of a zone surrounding the airport that was utilized by aircraft under the historical condition; and an available airspace for the current condition as a difference between the zone and the portion.

The exemplary embodiments are directed to an airspace predictor server, comprising: a transceiver communicating with an airport operator device utilized by an airport operator via a communications network; and a processor determining a current condition present at an airport, the processor querying historical data having a historical condition that is substantially similar to the current condition, the processor determining a portion of a zone surrounding the airport that was utilized by aircraft under the historical condition, the processor determining an available airspace for the current condition as a difference between the zone and the portion, wherein the transceiver transmits the available airspace to the airport operator device.

The exemplary embodiments are directed to a non-transitory computer readable storage medium with an executable program stored thereon, wherein the program instructs a microprocessor to perform operations comprising: determining a current condition present at an airport; querying historical data having a historical condition that is substantially similar to the current condition; determining a portion of a zone surrounding the airport that was utilized by aircraft under the historical condition; and determining an available airspace for the current condition as a difference between the zone and the portion.

### BRIEF DESCRIPTION OF THE DRAWINGS

FIG. 1 shows a system according to the exemplary embodiments.

FIG. 2 shows an airspace predictor server of FIG. 1 according to the exemplary embodiments.

FIGS. 3A-B show area maps used in determining available airspace according to the exemplary embodiments.

FIG. 4 shows a method for determining available airspace according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for determining availability of airspace surrounding an airport for use by unmanned aircraft. The exemplary embodiments provide a mechanism in which historical airspace usage data and corresponding condition data provide an estimate to determine the likely available airspace surrounding the airport. Accordingly, the exemplary embodiments provide a dynamic and tactical forecast of airspace use surrounding the airport to enable unmanned aircraft operations.

It is noted that the exemplary embodiments relate to an area surrounding an airport. Specifically, in view of FAA regulations, the exemplary embodiments relate particularly to a radius of 5 miles from an airport center. However, the exemplary embodiments may be utilized for any area of airspace that may be utilized by aircraft. Thus, the area surrounding the airport as used in the exemplary embodiments may represent any airspace through which aircraft may fly.

The exemplary embodiments provide a mechanism that determines the available airspace for unmanned aircraft within a 5-mile radius of an airport. Specifically, the mechanism according to the exemplary embodiments utilizes a comparison between current and historical conditions to identify a most probable availability of the 5-mile radius airspace surrounding the airport. Based on the probable availability to avoid any interference with ordinary operations at the airport, an airport operator may determine whether a request to utilize the 5-mile radius airspace surrounding the airport by an operator of an unmanned aircraft may be granted.

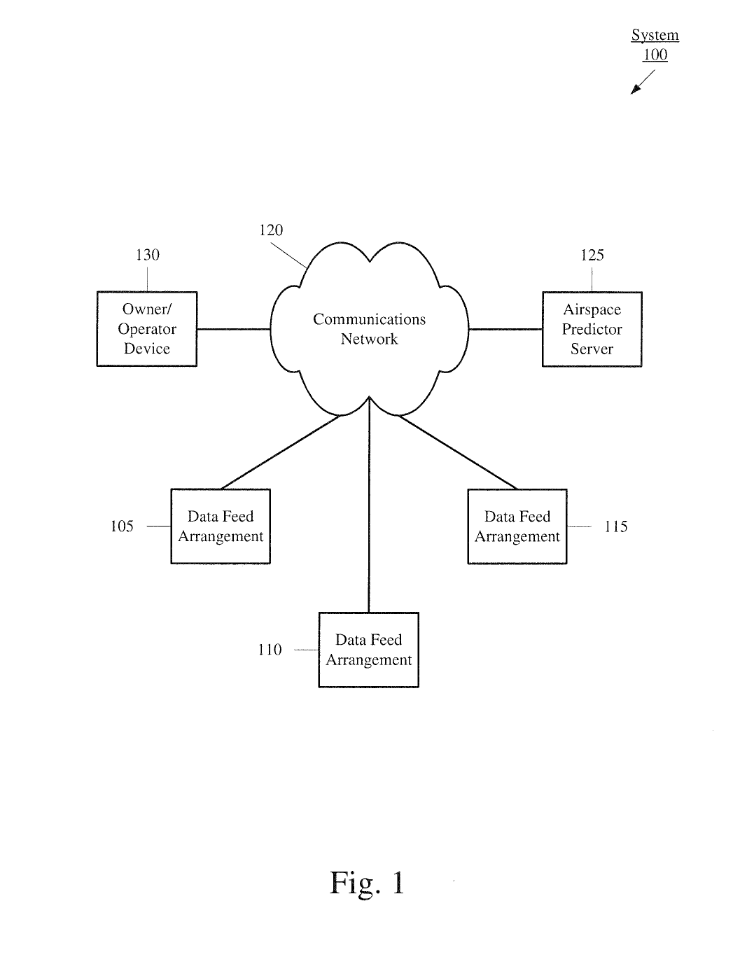

FIG. 1 shows a system 100 according to the exemplary embodiments. The system 100 relates to a communication between various components involved in determining the available airspace in a 5-mile radius surrounding an airport. Specifically, the system 100 may include a plurality of data feed arrangements 105-115, a communications network 120, an airspace predictor server 125, and an owner/operator device (hereinafter “airport operator device”) 130. As will be described in further detail below, the data feed arrangements 105-115 may provide data to the airspace predictor server 125. The airspace predictor server 125 may use the data from the data feed arrangements 105-115 along with saved data and/or additional data provided by the airport operator device 130 to determine the available airspace for unmanned aircraft under a set of conditions. The airspace predictor server 125 may then provide this information to the airport operator device 130 for their use.

The data feed arrangements 105-115 may be any system that provides pertinent data associated with determining available airspace. For example, the data feed arrangements 105-115 may be government data feeds such as FAA data feeds, National Weather Service feeds, etc. In another example, the data feed arrangements 105-115 may be third-party private data feeds, airport specific data feeds, owner/operator data feeds, etc. It is noted that where the data represented by the data feed arrangements 105-115 may originate from any source and is not relevant to the how the mechanism according to the exemplary embodiments operate.

It should also be noted that the system 100 illustrating a plurality of data feed arrangements 105-115 (specifically three arrangements) is only exemplary. Those skilled in the art will understand the system 100 may utilize any number of data feed arrangements including more or less than shown in the system 100. Furthermore, those skilled in the art will understand that the system 100 may not utilize any data feed arrangements if the information associated with the data feed arrangements 105-115 is readily available in a local storage component.

The communications network 120 may be configured to communicatively connect the various components of the system 100 to exchange data. The communications network 120 may represent any single or plurality of networks used by the components of the system 100 to communicate with one another. For example, if the airport operator device 130 is used at an airport, the communications network 120 may include a private network in which the airport operator device 130 may initially connect. The private network may connect to a network of an Internet Service Provider to connect to the Internet. Subsequently, through the Internet, a connection may be established to other electronic devices. It should be noted that the communications network 120 and all networks that may be included therein may be any type of network. For example, the communications network 120 may be a local area network (LAN), a wide area network (WAN), a virtual LAN (VLAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc.

The airport operator device 130 may represent any electronic device utilized by an airport operator that is configured to receive outputs from the airspace predictor server 125. For example, the airport operator device 130 may be a portable device such as a tablet, a laptop, etc. or a client stationary device such as a desktop terminal. The airport operator device 130 may include the necessary hardware, software, and/or firmware to perform the various operations associated with receiving the outputs and, for example, displaying the outputs for viewing by the airport operator. The airport operator device 130 may also include the required connectivity hardware, software, and firmware (e.g., transceiver) to establish a connection with the communications network 130 to further establish a connection with the other components of the system 100.

The airport operator device 130 may include further functionalities. For example, as described above, the airspace predictor server 125 may receive data from the data feed arrangements 105-115 but may also receive data and/or inputs from the airport operator device 130. Using the above noted hardware/software, the airport operator device 130 may receive inputs from the airport operator and transmit the inputs to the airspace predictor server 125 which determines outputs at least partially on these inputs. In another example, the airport operator device 130 may receive a request from an operator of an unmanned aircraft to use airspace within the 5-mile radius of the airport associated with the airport operator device 130. Accordingly, the airport operator device 130 may transmit a response to the request based on the outputs from the airspace predictor server 125.

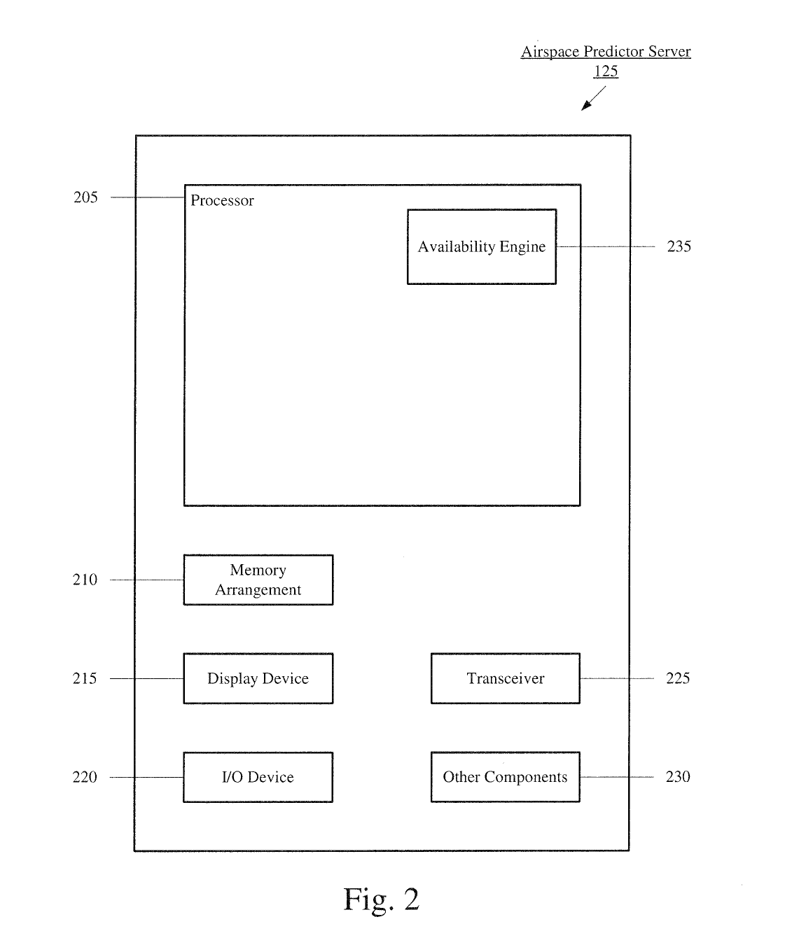

As described above, the airspace predictor server 125 may be a component of the system 100. Specifically, the airspace predictor server 125 may perform functionalities associated with determining available airspace within a 5-mile radius of an airport. FIG. 2 shows the airspace predictor server 125 of FIG. 1 according to the exemplary embodiments. The airspace predictor server 125 may provide various functionalities associated with determining available airspace. Although the airspace predictor server 125 is described as a network component (e.g., a server), the airspace predictor server 125 may be embodied in a variety of ways such as a portable device (e.g., a tablet, a smartphone, a laptop, etc.), a client stationary device (e.g., a desktop terminal), incorporated into the airport operator device 130, etc. The airspace predictor server 125 may include a processor 205, a memory arrangement 210, a display device 215, an input and output (I/O) device 220, a transceiver 225, and other components 230 (e.g., an imager, an audio I/O device, a battery, a data acquisition device, ports to electrically connect the airspace predictor server 125 to other electronic devices, etc.).

The processor 205 may be configured to execute a plurality of applications of the airspace predictor server 125. Specifically, the processor 205 may execute an availability engine 235 that utilizes data from the data feed arrangements 105-115 as well as any further data including inputs from the airport operator device 130 to determine the available airspace in a 5-mile radius surrounding an airport. As will be described in further detail below, the availability engine 235 may utilize various different types of data in determining the available airspace.

It should be noted that the above noted availability engine 235 being an application (e.g., a program) executed by the processor 205 is only exemplary. The functionality associated with the availability engine 235 may also be represented as components of one or more multifunctional programs, a separate incorporated component of the airspace predictor server 125 or may be a modular component coupled to the airspace predictor server 125, e.g., an integrated circuit with or without firmware.

The memory 210 may be a hardware component configured to store data related to operations performed by the airspace predictor server 125. Specifically, the memory 210 may store data related to the operations of the availability engine 235 including received data from the data feed arrangements 105-115. The display device 215 may be a hardware component configured to show data to a user while the I/O device 220 may be a hardware component that enables the user to enter inputs. For example, an administrator of the airspace predictor server 125 may maintain and update the functionalities of the airspace predictor server 125 through user interfaces shown on the display device 215 with inputs entered with the I/O device 220. It should be noted that the display device 215 and the I/O device 220 may be separate components or integrated together such as a touchscreen. The transceiver 225 may be a hardware component configured to transmit and/or receive data via the communications network 110.

According to the exemplary embodiments, the airspace predictor server 125 via the availability engine 235 may be configured to perform a variety of different operations. In an exemplary operation, the airspace predictor server 125 may determine paths in which aircraft land and take off for a particular time period on a particular day. Accordingly, based on this operation, the airspace predictor server 125 may determine the available airspace for use by unmanned aircraft.

As those skilled in the art will understand, the available airspace around an airport is directly correlated to airport runway use as aircraft taking off enter an area of the airspace from the runway and aircraft landing exit an area of the airspace onto the runway. Therefore, determining the airport runway use may provide directly correlated information in determining the airspace that is available for use by other aircraft as the paths taken by aircraft during take off and landing at a given time period of a given day under a set of conditions are substantially the same. Furthermore, airport runway use may be a function based on several variables. For example, the variables may include weather factors (e.g., wind direction, wind speed, ceiling, visibility, precipitation type, thunderstorms, lightning, snow, etc.), environmental factors (e.g., noise abatement, runway rotation policies, community agreements, etc.), operational advantages (e.g., when weather is not a factor and any runway configuration is available for use, a highest capacity configuration is used for high traffic demand while environmental practices may take priority for normal traffic demand), construction and/or airport conditions (e.g., terminal renovations, runway repairs, etc.), etc.

In performing the path determination operation, the airspace predictor server 125 may first receive data from the data feed arrangements 105-115. The data from the data feed arrangements 105-115 may be received in a variety of different manners. For example, the airspace predictor server 125 may continually receive the data from the data feed arrangements 105-115 such that the airspace predictor server 125 may have any relevant information stored locally on the memory arrangement 210. In another example, the airspace predictor server 125 may request the data from the data feed arrangements 105-115 when the data is required to perform further operations. In a further example, the airspace predictor server 125 may utilize a combination of the above examples in which data from select data feed arrangements 105-115 are received continually (e.g., weather information) whereas the airspace predictor server 125 requests information from other data feed arrangements 105-115.

As data is received by the airspace predictor server 125 (either continually or as requested), the data may be stored in the memory arrangement 210. When stored beyond a predetermined time period from a current time, the data may be considered historical data. The historical data stored locally on the memory arrangement 210 may be utilized by the airspace predictor server 125 for a variety of reasons (as will be described below). However, as those skilled in the art will understand, it may be unreasonable to store the data indefinitely for many different considerations. Thus, the historical data may be stored locally for a predetermined amount of time (e.g., up to a year, up to 5 years, etc.). As the volume of the historical data stored locally may still reach an unreasonable size, the airspace predictor server 125 may also utilize a remote data repository (e.g., that utilizes a common private network with the airspace predictor server 125). For exemplary purposes, it may be assumed that all historical data may be available from the data feed arrangements 105-115.

The data received from the data feed arrangements 105-115 may include current information relating to the airport. The current information may include various different types of information. For example, the different types of current information may be weather information, runway configurations, departure and arrival rates, flight schedules, etc. Again, as with any information that is received by the airspace predictor server 125, the source of the information may be from a variety of information sources including the data feed arrangements 105-115 that is received continuously (and available locally) or requested. The current information may also be information that was recorded or determined within a predetermined time period from a current time. For example, information may be defined as current if the information was recorded within 30 minutes of the current time.

In addition to the current airport information, the airspace predictor server 125 may also receive historical information. Initially, as noted above, historical information may be stored as it is received from the data feed arrangements 105-115. The historical information may also include a variety of different types of data which are substantially similar to those described above with the current information. Furthermore, the historical information may also include other types of data which are only configured to be available after sufficient historical data is available or to analyze a particular historical time period. Thus, the historical information may include all of the different types of information as the current information and may further include additional types of information such as those described above.

To determine the available airspace, the airspace predictor server 125 may initially utilize the current information to identify the time (e.g., day and time) and conditions (e.g., weather, runway configuration, etc.) that are currently present. The airspace predictor server 125 may also utilize the historical information to determine airport operations such as runway use that have substantially similar times and/or conditions to the present time and/or conditions. The determined airport operations may accordingly estimate the average paths taken by manned aircraft in the 5-mile radius surrounding the airport. In this manner, the airspace predictor server 125 may predict an estimate of the available airspace in the 5-mile radius surrounding the airport. It is noted that the time may also be considered a condition and is emphasized as one type of condition that is used by the exemplary embodiments. It is also noted that the use of time as a primary condition is only exemplary as other conditions may also serve as the primary condition or be weighted for consideration over than time.

The airspace predictor server 125 may determine the available airspace in a variety of different manners. In a first example, the airspace predictor server 125 may determine an expected available airspace based on time. That is, the current information may indicate the time and day and the historical information corresponding to the time and day may be determined. The paths of aircraft during the time and day as indicated in the historical information may be used in determining the available airspace with an assumption that the time and day historically would have a similar result currently. Specifically, the airspace predictor server 125 may utilize the time of day as a means of limiting the historical information. For example, the time of day may limit the historical information to substantially similar days (e.g., weekdays, weekends, Fridays, etc.) and/or to substantially similar times (e.g., the specific hour for which the prediction will be made and the two hours around that time).

The available airspace that is determined based on time may relate to an “ordinary” runway use in which constraints or other factors are not present. As those skilled in the art will understand, the day and time may define how runways are used at an airport. For example, a direction of the sun may adversely affect how a pilot will operate the aircraft, particularly for landings. As the position of the sun differs based on the day and the time, the ordinary runway use may be determined. The ordinary runway use may thereby be used in determining the paths taken by aircraft and subsequently the available airspace which may be the negative space in the 5-mile radius surrounding the airport that is not being used by the manned aircraft. In this manner, the ordinary runway use may be used in determining an ordinary available airspace based on time.

In a second example, the airspace predictor server 125 may determine an expected available airspace based on other constraints and factors including weather, runway conditions, etc. Thus, the current information may indicate constraints and factors and the historical information may be used to determine historical constraints and factors that are substantially similar to those currently. The paths of aircraft under the constraints and factors as indicated in the historical information may be used in determining the available airspace with an assumption that the constraints and factors historically would have a similar result currently.

In a third example, the airspace predictor server 125 may utilize a combination of the above examples. For example, the airspace predictor server 125 may utilize the current information to determine the current time and use the historical information to initially determine the ordinary available airspace based on time. The airspace predictor server 125 may subsequently utilize the current information to determine the current constraints and factors and use the historical information to determine how paths of aircraft are affected. Accordingly, the airspace predictor server 125 may determine a modified available airspace which is the ordinary available airspace as modified by the constraints and factors. In another example, an opposite configuration may be used in which the available airspace is determined first with the constraints and factors to be modified using time. In a further example, a concurrent configuration may be used in which the available airspace is determined using time, constraints, and factors at the same time.

As described above, the current information and the historical information may include constraints or factors that may affect the paths taken by aircraft on runways of an airport. In a first example, the current information and historical information may be associated with a constraint related to weather. Thus, the airspace predictor server 125 may receive as input weather-related information such as Terminal Aerodrome Forecasts (TAF) for a certain amount of time (e.g., the next 8 hours). The airspace predictor server 125 may utilize the TAF to determine the expected weather conditions during the forecast time. In this manner, the current weather conditions based on the forecast may be utilized as the basis to query for similar weather conditions in actual historical information. For example, one of the data feed arrangements 105-115 may provide the airspace predictor server 125 with the TAF for the next eight hours. The forecast based on the TAF may indicate a sub-optimal weather condition (e.g., strong winds of 10 knots from the Northwest). Those skilled in the art will understand that such a condition is not optimal. Therefore, the current information may be a constraint or factor that affects the paths taken by aircraft for runway use. It is noted that the forecast from the TAF may be a constant or dynamic forecast over the forecast time period and the exemplary embodiments may utilize any forecast information to determine the weather conditions.

Upon receiving the TAF, the airspace predictor server 125 may utilize the historical information to determine how paths of aircraft are affected under substantially similar constraints and factors as the current constraints and factors. The historical information may indicate all the paths of the aircraft with similar constraints and factors. Using the above example with the current information indicating winds of 10 knots from the Northwest, substantially similar weather conditions in the historical information may be winds from the Northwest ranging from 5 knots to 15 knots as well as winds from the North ranging from 5 knots to 10 knots. Accordingly, the historical paths of aircraft having substantially similar weather conditions may be determined.

After analyzing the paths in the historical information, the airspace predictor server 125 may take an average of the historical paths. The average paths may provide an estimate as to an airspace area within the 5-mile radius of the airport that manned aircraft are utilizing under substantially similar weather constraints. As there may also be outliers in the historical information, the average of the historical paths may maximize both the airspace area used and unused by the manned aircraft under similar weather conditions. It is noted that the amount of historical information used to make the estimation may vary. For example, the airspace predictor server 125 may use historical information from the past 3 months. In another example, the airspace predictor server 125 may use the past 30 events having similar constraints. Thus, there may be a wide range of historical information that may be used for prediction purposes.

In a second example of constraints, the current information and historical information may be associated with a constraint related to runway conditions and/or configurations. For example, the runway conditions and/or configurations may be whether one or more runways for a specific terminal at the airport are currently operational or are not being used. The paths of aircraft may be affected from the runway conditions, particularly when there is a high rate of take offs and landings. Thus, the historical information indicating the paths of aircraft under substantially similar runway conditions may be utilized in determining available airspace. It is noted that the runway conditions may represent any other data that is input to the airspace predictor server 125. For example, other conditions including those existing outside the airport may be utilized in determining how the available airspace and/or ordinary available airspace is affected.

It is again noted that the use of the time of day as a primary condition is only exemplary. The exemplary embodiments may also utilize the constraints described above in determined the available airspace within a 5-mile radius surrounding an airport. For example, a non-time constraint may be used independently of the time of day. The non-time constraint may also be used with the time of day but be considered with a higher degree of importance than the time of day. For example, the non-time constraint may be snow conditions which may supersede any time of day consideration.

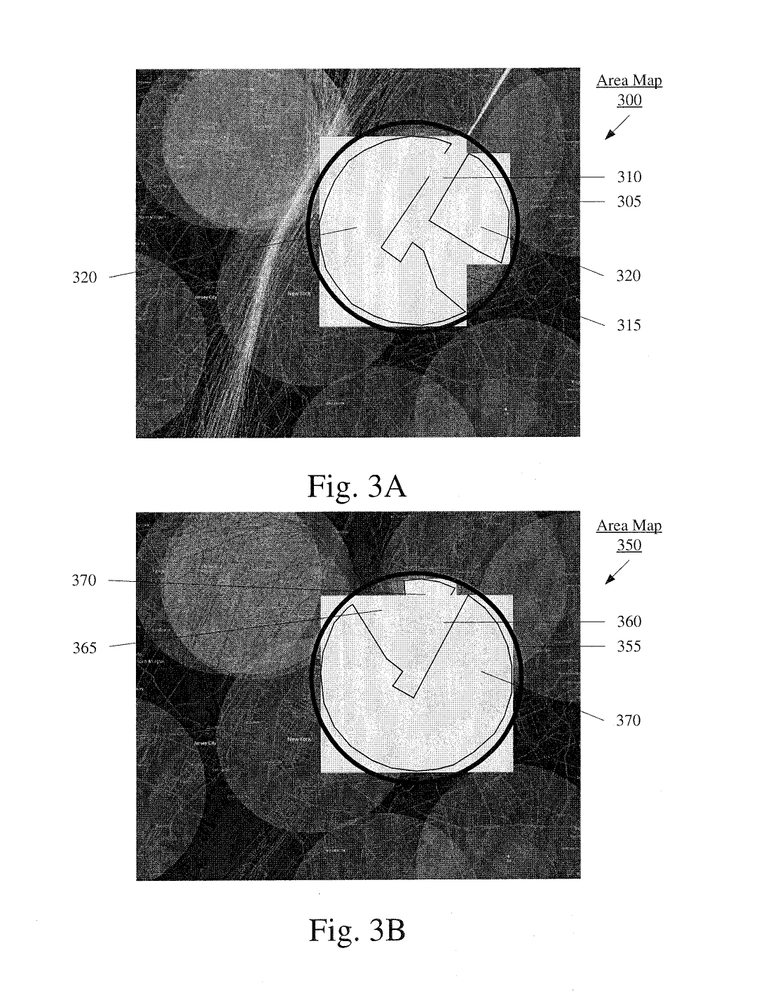

FIGS. 3A-B show area maps 300, 350 used in determining available airspace according to the exemplary embodiments. Specifically, the area maps 300, 350 illustrate how the airspace predictor server 125 determines the available airspace within a 5-mile radius surrounding an airport under a set of conditions. The area maps 300, 350 may be for identical geographical areas. For exemplary purposes, the area map 300 of FIG. 3A may relate to a first day at a first time under a first set of conditions while the area map 350 of FIG. 3B may relate to a second day at a second time under a second set of conditions. It is noted that at least one of the first day, the first time, and the first set of conditions may be different from the second day, the second time, and the second set of conditions, respectively. For example, the first day may be identical to the second day but the first time and the first set of conditions may be different from the second time and the second set of conditions. In another example, the first day and the first time may be identical to the second day and the second time but the first set of conditions may be different from the second set of conditions.

As illustrated in the first area map 300 of FIG. 3A, there may be a zone 305 having a radius around an airport. That is, the center of the zone 305 may be the center of the airport. The zone 305 may correspond to the 5-mile radius surrounding the airport. Thus, the available airspace that may be determined may be for a portion of the zone 305 that is not utilized by manned aircraft. The manned aircraft may be taking off using departure portion 310 and landing using arrival portion 315. The departure portion 310 and the arrival portion 315 may relate specifically to airspace. Thus, the combined departure portion 310 and the arrival portion 315 may represent a total area of the zone 305 that is being utilized by manned aircraft under the time and conditions associated with the area map 300. Accordingly, available airspace 320 may be determined as the difference between the zone 305 and the combined departure portion 310 and the arrival portion 315. In this manner, when the current information indicates that the time and conditions are substantially similar to those present in the area map 300, the available airspace that is determined by the airspace predictor server 125 may be the available airspace 320.

As illustrated in the second area map 350 of FIG. 3B, there may be a zone 355 having a radius around an airport. That is, the center of the zone 355 may be the center of the airport. As the area maps 300, 350 are for identical geographic locations, the zone 305 and the zone 355 may be for identical 5-mile radius areas surrounding the airport. The manned aircraft may be taking off using departure portion 360 and landing using arrival portion 365. Thus, the combined departure portion 360 and the arrival portion 365 may represent a total area of the zone 355 that is being utilized by manned aircraft under the time and conditions associated with the area map 350. The departure portion 360 may be substantially similar to the departure portion 310. However, the arrival portion 365 is significantly different from the arrival portion 315. As described above, although identical geographic locations, the time and conditions may affect the paths taken by manned aircraft. Therefore, the arrival portion 365 and the arrival portion 315 may be different. It is noted that the use of substantially similar departure portions 310, 360 is only exemplary and the departure portions may also be different based on time and conditions. Available airspace 370 may be determined as the difference between the zone 355 and the combined departure portion 360 and the arrival portion 365. In this manner, when the current information indicates that the time and conditions are substantially similar to those present in the area map 350, the available airspace that is determined by the airspace predictor server 125 may be the available airspace 370.

It should be noted that the available airspace 370 may be modified through various additional considerations. For example, the departure portions 310, 360 and the arrival portions 315, 365 may represent an average pathway taken for departures and arrivals of manned aircraft. However, as those skilled in the art will understand, there may be outliers relative to the average pathway. Thus, an area covered by the departure portions 310, 360 and the arrival portions 315, 365 may include a buffer extension to incorporate the outliers. Through incorporation of the buffer extension, the available airspace 320, 370 may be updated.

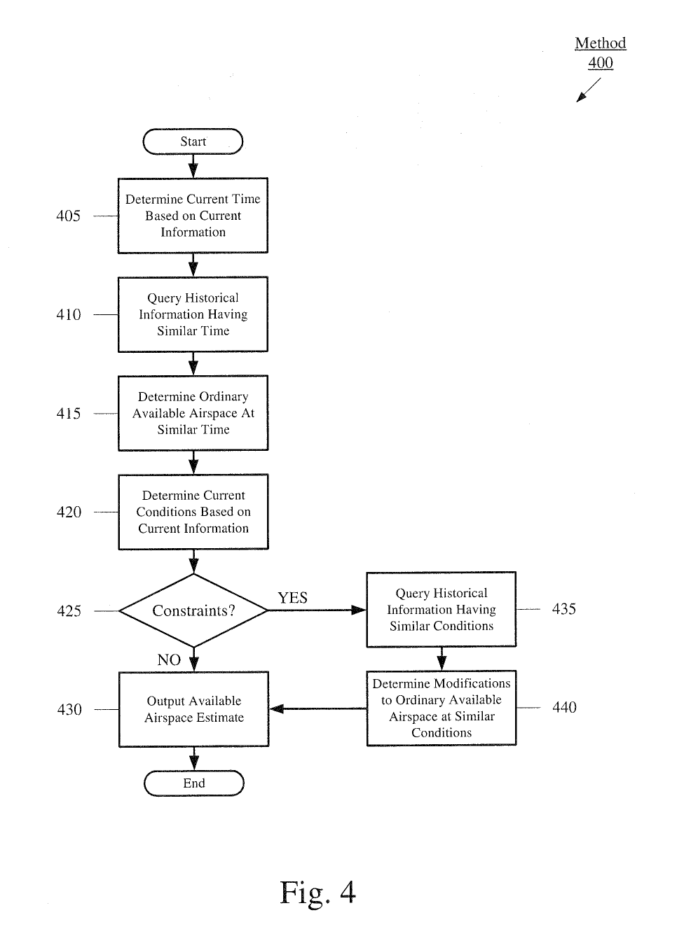

FIG. 4 shows a method 400 for determining available airspace according to the exemplary embodiments. Specifically, the method 400 may relate to an operation that is performed by the availability engine 235 of the airspace predictor server 125 based on current and historical information of an airport. Accordingly, the method 400 will be described from the perspective of the airspace predictor server 125. The method 400 will also be described with regard to the system 100 of FIG. 1 and the airspace predictor server 125 of FIG. 2.

It is noted that the method 400 is described with respect to initially generating an ordinary available airspace estimate based on a time parameter (e.g., day and time of day) and subsequently modifying the ordinary available airspace based on other constraints. However, as described above, utilizing an ordinary available airspace as well as generating the ordinary available airspace based on the time parameter are only exemplary. The exemplary embodiments may utilize any ordering of the time and constraints in determining the available airspace estimate.

In step 405, the airspace predictor server 125 receives current information and determines a current time based on the current information. As described above, the current information may be received from a variety of sources including remote sources such as the data feed arrangements 105-115 and local sources such as the memory arrangement 210 or local network data repositories. With regard to the current time, the airspace predictor server 125 may determine the current time through its own time tracking.

In step 410, the airspace predictor server 125 receives historical information and queries the historical information for airport operations such as aircraft paths during a substantially similar time as the current time. For example, the time may be granular such as a set of hours on a given day of the week in a given month of the year. Thus, the substantially similar time may be the same set of hours on the same given day of the week in the same given month of the year but in a past year relative to the current year. In another example, the time may be only the set of hours. Thus, the substantially similar time may be any day (e.g., previous day) having the same set of hours.

In step 415, the airspace predictor server 125 determines an ordinary available airspace based on time. As described above, the actual paths taken by manned aircraft as determined from the historical information at the substantially similar time as the current time may be averaged to determine an estimate of the paths including aircraft both taking off and landing. The paths taken historically may be assumed to be an estimate for the current time. Accordingly, a difference between a 5-mile radius zone (e.g., zone 305) and a combination of a departure portion (e.g., departure portion 310) with an arrival portion (e.g., arrival portion 315) may estimate the ordinary available airspace (e.g., available airspace 320).

In step 420, the airspace predictor server 125 utilizes the current information and determines current conditions based on the current information. The current information may relate to possible constraints and factors that may exist at the airport. For example, the conditions may be weather conditions, airport operation conditions, etc.

In step 425, the airspace predictor server 125 determines whether the current conditions are indicative of a constraint. Specifically, the constraint may be any condition that affects the paths that would otherwise be present in the ordinary available airspace. For example, a constraint may be a weather condition such as winds from a particular direction that exceeds a predetermined minimum strength. Thus, if a wind condition has at least the predetermined minimum strength, the airspace predictor server 125 may realize that the ordinary available airspace is likely to be modified. In contrast, if a wind condition exists but is less than the predetermined minimum strength, the airspace predictor server 125 may realize that the ordinary available airspace is likely to go unchanged. In another example, a constraint may be an airport condition such as a runway being unable to be used. The airspace predictor server 125 may utilize a predetermined list of constraints that affect aircraft paths. As described above, the historical information may be used for a variety of reasons. The identification of the constraints may be determined using the historical information.

If the current conditions do not indicate that the paths of the aircraft are affected, the airspace predictor server 125 continues the method 400 to step 430. In step 430, the airspace predictor server 125 outputs an estimate of the available airspace. With no constraints being present, the airspace predictor server 125 may maintain the ordinary available airspace based on time alone. In this manner, the airspace predictor server 125 may dynamically determine the available airspace based at least on time.

If the current conditions indicate that the paths of the aircraft will likely be affected, the airspace predictor server 125 continues the method 400 from step 425 to step 435. In step 435, the airspace predictor server 125 utilizes the historical information and queries the historical information for airport operations such as aircraft paths during substantially similar conditions as the current conditions. For example, the current conditions may indicate a forecast for precipitation. Thus, the substantially similar conditions may be the same type of precipitation having a similar severity. In another example, the conditions may be that a runway is not operational. Thus, the substantially similar conditions may be when the runway has been closed. In fact, the reason (e.g., icy conditions, construction, etc.) for closing the runway may be irrelevant.

In step 440, the airspace predictor server 125 determines modifications to the ordinary available airspace based on the similar conditions. As described above, the actual paths taken by manned aircraft as determined from the historical information at the substantially similar conditions as the current condition may be determined to identify whether the ordinary runway use is affected (e.g., the aircraft are forced to use a different path). The modification may accordingly be used to determined an updated available airspace that is the ordinary available airspace modified with the new path information. Accordingly, a difference between a 5-mile radius zone (e.g., zone 355) and a combination of a modified departure portion (e.g., departure portion 360) with a modified arrival portion (e.g., arrival portion 365) may estimate the ordinary available airspace (e.g., available airspace 370).

If the current conditions indicate that the paths of the aircraft are likely to be affected, the airspace predictor server 125 continues the method 400 through steps 435 and 440 and subsequently to step 430. In step 430, the airspace predictor server 125 outputs an estimate of the available airspace. With constraints being present, the airspace predictor server 125 may utilize the modified available airspace based on time and conditions. In this manner, the airspace predictor server 125 may dynamically determine the available airspace based at least on time and conditions.

It should be noted that the method 400 may include further steps, particularly with regard to when, for who, and why the method 400 is being utilized. In a first exemplary step, the method 400 may receive a request from an airport operator utilizing the airport operator device 130. For example, the airport operator may have received a request from an operator of an unmanned aircraft to utilize the airspace within a 5-mile radius of the airport. Thus, to properly respond to the unmanned aircraft operator, the airport operator may need to know the available airspace. In a second exemplary step, the method 400 may transmit the available airspace to the airport operator. In further steps, the available airspace may be configured for a particular display including graphical representations of the available airspace. For example, the area maps 300, 350 may be generated for review by the airport operator. In this manner, the airport operator may readily recognize whether an unmanned aircraft is allowed to utilize any particular portion of the 5-mile radius surrounding the airport.

The exemplary embodiments provide a device, system, and method of dynamically determining available airspace. Specifically, the available airspace may be determined for a 5-mile radius surrounding an airport. An airspace predictor server may initially determine a current time and/or current conditions at the airport. The airspace predictor may subsequently query historical information to determine a substantially similar time and/or substantially similar conditions. The paths of aircraft determined from the historical information may provide an estimate of the current paths of aircraft such that the available airspace may be determined as a remaining area that does not include the portions covered by the current paths. Thus, when a request for an unmanned aircraft to utilize a portion of the airspace within the 5-mile radius surround the airport is received, a proper response may be provided to the request based on whether the portion of the airspace is available for use by the unmanned aircraft.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
at an airspace predictor server:
determining a current condition present at an airport;
querying historical data having a historical condition that is substantially similar to the current condition;
determining a portion of a zone surrounding the airport that was utilized by aircraft under the historical condition; and
determining an available airspace for the current condition as a difference between the zone and the portion.

2. The method of claim 1, wherein the current condition is at least one of a current time at the airport, a current weather condition at the airport, and a current airport operating condition at the airport, and wherein the historical condition is corresponding one of a historical time at the airport, a historical weather condition at the airport, and a historical airport operating condition at the airport.

3. The method of claim 2, wherein the current time is at least one of a time of a day, a day of a week, a day of a month, a day of a year and wherein the historical time corresponds to the at least one of the time of the day, the day of the week, the day of the month, the day of the year.

4. The method of claim 2, wherein the current weather condition is a first wind condition having a first known direction and a first known strength and wherein the historical weather condition is a second wind condition having at least one first known direction and a second, respective known strength range, the at least one first known direction including at least a portion of the first known direction, the second, respective known strength range including the first known strength.

5. The method of claim 2, wherein the current airport operating condition is a current runway operational condition and wherein the historical airport operating condition is a historical runway operational condition, the current and historical runway operational conditions being whether a runway is one of open and closed.

6. The method of claim 1, further comprising:
receiving a first request from an airport operator device utilized by an airport operator for the available airspace; and
transmitting the available airspace to the airport operator device.

7. The method of claim 6, further comprising:
generating an area map illustrating the available airspace relative to the airport.

8. The method of claim 6, wherein the first request is received based on a second request received from an unmanned aircraft operator whose unmanned aircraft is to enter the zone.

9. The method of claim 8, wherein the aircraft is manned aircraft and the available airspace is used by the unmanned aircraft.

10. The method of claim 1, wherein the zone is a 5-mile radius area, a center of which coincides with a center of the airport.

11. An airspace predictor server, comprising:
a transceiver communicating with an airport operator device utilized by an airport operator via a communications network; and
a processor determining a current condition present at an airport, the processor querying historical data having a historical condition that is substantially similar to the current condition, the processor determining a portion of a zone surrounding the airport that was utilized by aircraft under the historical condition, the processor determining an available airspace for the current condition as a difference between the zone and the portion,
wherein the transceiver transmits the available airspace to the airport operator device.

12. The airspace predictor server of claim 11, wherein the current condition is at least one of a current time at the airport, a current weather condition at the airport, and a current airport operating condition at the airport, and wherein the historical condition is corresponding one of a historical time at the airport, a historical weather condition at the airport, and a historical airport operating condition at the airport.

13. The airspace predictor server of claim 12, wherein the current time is at least one of a time of a day, a day of a week, a day of a month, a day of a year and wherein the historical time corresponds to the at least one of the time of the day, the day of the week, the day of the month, the day of the year.

14. The airspace predictor server of claim 11, wherein the current weather condition is a first wind condition having a first known direction and a first known strength and wherein the historical weather condition is a second wind condition having at least one first known direction and a second, respective known strength range, the at least one first known direction including at least a portion of the first known direction, the second, respective known strength range including the first known strength.

15. The airspace predictor server of claim 11, wherein the current airport operating condition is a current runway operational condition and wherein the historical airport operating condition is a historical runway operational condition, the current and historical runway operational conditions being whether a runway is one of open and closed.

16. The airspace predictor server of claim 1, wherein the transceiver further receives a first request from the airport operator device for the available airspace.

17. The airspace predictor server of claim 16, wherein the processor further generates an area map illustrating the available airspace relative to the airport.

18. The airspace predictor server of claim 6, wherein the first request is received based on a second request received from an unmanned aircraft operator whose unmanned aircraft is to enter the zone.

19. The airspace predictor server of claim 18, wherein the aircraft is manned aircraft and the available airspace is used by the unmanned aircraft.

20. A non-transitory computer readable storage medium with an executable program stored thereon, wherein the program instructs a microprocessor to perform operations comprising:
determining a current condition present at an airport;
querying historical data having a historical condition that is substantially similar to the current condition;
determining a portion of a zone surrounding the airport that was utilized by aircraft under the historical condition; and
determining an available airspace for the current condition as a difference between the zone and the portion.
